(19) United States
(12) Patent Application Publication
(10) Pub. No.: US 2020/0364804 A1
(43) Pub. Date: Nov. 19, 2020

(54) CROWD FUNDRAISING SOCIAL NETWORK SYSTEM WITH PAY IT FORWARD TRANSACTIONS AND RELATED METHODS

(71) Applicant: Eric BECHTOLD, Bonita Springs, FL (US)

(72) Inventor: Eric BECHTOLD, Bonita Springs, FL (US)

(21) Appl. No.: 16/410,534

(22) Filed: May 13, 2019

(51) Int. Cl. G06Q 50/00; G06Q 30/02

(52) U.S. Cl. CPC G06Q 50/01; G06Q 30/0279

(57) ABSTRACT

A crowd fundraising social network system includes a server, and devices in communication with the server and having respective users. The server is configured to provide a fundraising social network. The respective users are members in the fundraising social network. The server is configured to receive a given donation for a given fundraising effort within the fundraising social network. The given fundraising effort is connected to another fundraising effort, and the given fundraising effort has a given initial posting user. The other fundraising effort has another initial posting user. The server is configured to distribute the given donation between the given fundraising effort and any connected other fundraising efforts based upon a given qualifying donation value for the respective posting users of the fundraising efforts so connected. The qualifying donation values are threshold prior donation values by the respective posting users.

### TECHNICAL FIELD

The present disclosure relates to the field of online social networks, and, more particularly, to crowd fundraising social networks and related methods.

### BACKGROUND

Social networks have become pervasive and diverse in modern society. Indeed, with the leading social networking service serving over a billion users worldwide, development of social networks has progressed quickly, for example, Facebook, Twitter, and Instagram. Indeed, with the maturing of the social network market, more use-specific social networks have been deployed, such as Twitter (short text based) and Instagram (picture based). One specific type of social network is the crowdfunding social network, for example, Kickstarter, and GoFundMe. A potential drawback to existing crowdfunding approaches is the endeavor is inherently self-interested and one-way. In other words, the poster of a fundraising effort simply posts and receives funds.

### SUMMARY

In an example embodiment of the disclosure, a crowd fundraising social network system may comprise a server, and a plurality of devices in communication with the server and having respective users. The server may be configured to provide a fundraising social network. The respective users may be members in the fundraising social network. The server may be configured to receive a given donation for a given fundraising effort within the fundraising social network. The given fundraising effort will be connected to at least one other fundraising effort, and the given fundraising effort will have a given initial posting user. The at least one other fundraising effort will have at least one other initial posting user. The server may be configured to distribute the given donation between the given fundraising effort and the at least one other fundraising effort based upon a given qualifying donation value for the given initial posting user. The given qualifying donation value may comprise a threshold prior donation value by the given initial posting user.

More specifically, the server may be configured to distribute the given donation between the given fundraising effort and the at least one other fundraising effort based upon the qualifying donation values of identified users of this transaction. When the given donation is greater than the given qualifying donation value, the server may be configured to distribute a first set percentage of the given qualifying donation value to the given fundraising effort. The server may be configured to distribute the given donation minus the first set percentage of the given qualifying donation value to the at least one other fundraising effort based upon the at least one other qualifying donation value of the at least one other initial posting user. Subsequent to distribution of the given donation minus the first set percentage of the given qualifying donation value to the at least one other fundraising effort, if there exists an excess amount, the server may then distribute the excess amount to at least one multi-degree connected fundraising effort.

Additionally, when the given donation is less than the given qualifying donation value, the server may be configured to distribute a second set percentage of the given donation to the given fundraising effort. The server may be configured to distribute the given donation minus the second set percentage of the given donation to the at least one other fundraising effort based upon the at least one other qualifying donation value of the at least one other initial posting user. Subsequent to distribution of the given donation minus the second set percentage of the given donation to the at least one other fundraising effort, if there exists an excess amount, the server may then distribute the excess amount to at least one multi-degree connected fundraising effort. The server is configured to define the threshold prior donation value by the given initial posting user based upon an accumulated donation value by the given initial posting user to an initial fundraising effort.

Another aspect is directed to a method for operating a crowd fundraising social network system. The method may include operating a plurality of devices in communication with a server, the plurality of devices having respective users, and providing a fundraising social network, the respective users being members in the fundraising social network. The method may comprise receiving a given donation for a given fundraising effort within the fundraising social network. The given fundraising effort will be connected to at least one other fundraising effort, and the given fundraising effort will have a given initial posting user. The at least one other fundraising effort will have at least one other initial posting user. The method may comprise distributing the given donation between the given fundraising effort and the at least one other fundraising effort based upon a given qualifying donation value for the given initial posting user. The given qualifying donation value may include a threshold prior donation value by the given initial posting user.

Leverage via Connections—Users who have donated to another user are connected. When the user then promotes their own campaign, that user is necessarily also promoting the connected user(s), creating exposure for the connected campaign(s) in a way unique to the present disclosure.

### BRIEF DESCRIPTION OF THE DRAWINGS

FIG. 1 is a schematic diagram of a first example embodiment of a crowd fundraising social network system, according to the present disclosure.

FIGS. 2 and 3 are flowcharts illustrating operation of the crowd fundraising social network system of FIG. 1.

FIGS. 4A-4C are schematic diagrams of connected fundraising efforts in the crowd fundraising social network system of FIG. 1, showing examples of differing donation values flowing through the described process.

FIGS. 5A-5E are screenshots of a web user interface for an example embodiment of the crowd fundraising social network system, according to the present disclosure, as viewed by someone wishing to donate to a fundraising effort.

FIGS. 6A-6F are screenshots of a web user interface for an example embodiment of the crowd fundraising social network system, according to the present disclosure, as viewed by a logged-in first-class user who has at least one listed fundraising effort.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

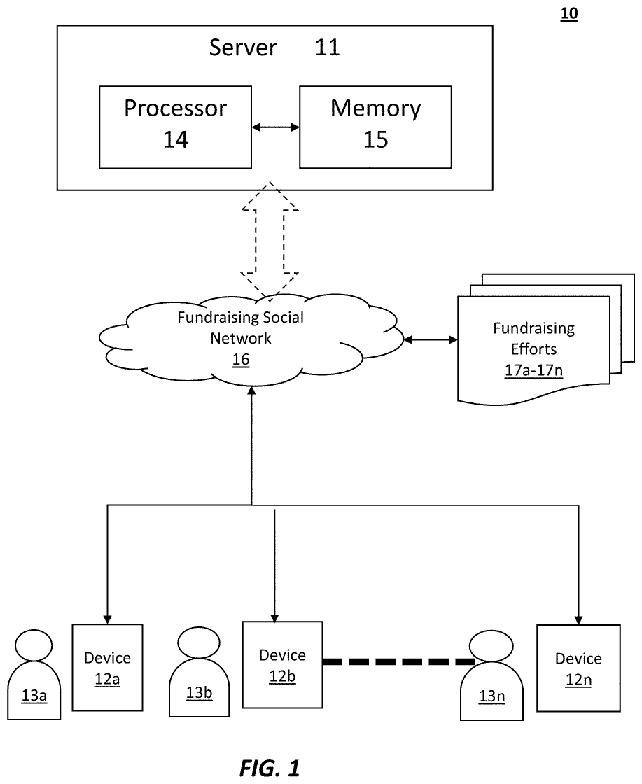

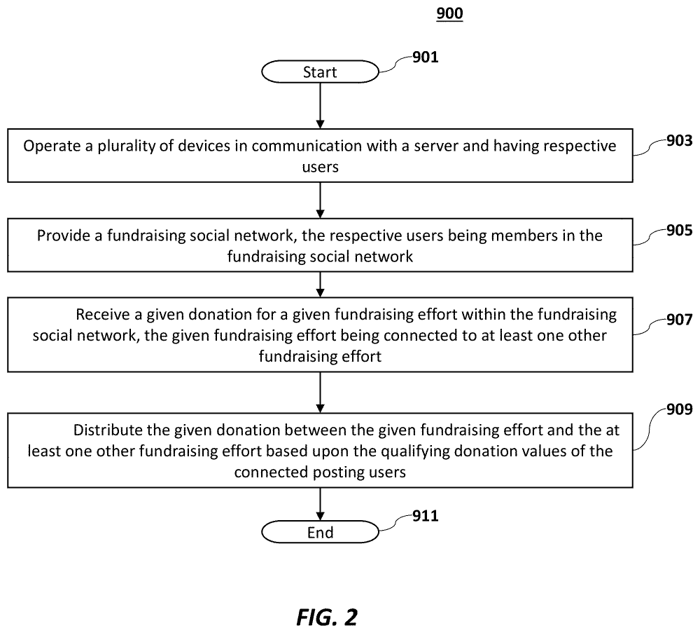

Referring initially to FIGS. 1-2, a crowd fundraising social network system 10 according to the present disclosure is now described. Also, with reference to flowchart 900, a method for operating the crowd fundraising social network system 10 is also now described. (Block 901). The crowd fundraising social network system 10 illustratively includes a server 11, and a plurality of devices 12a-12n (e.g. cellular devices, tablet computing devices, personal computing devices, or the like) in communication with the server and having respective users 13a-13n associated therewith. (Block 903).

The server 11 illustratively includes a processor 14 and memory 15 cooperating therewith. The server 11 may comprise assigned computing resources on a cloud-based computing platform, such as Amazon Web Services, Google Cloud Platform, or Microsoft Azure. In other embodiments, the server 11 may comprise one or more local computing devices coupled to a network, such as the Internet.

The server 11 is configured to provide a fundraising social network 16. (Block 905). The fundraising social network 16 includes the respective users 13a-13n being members in the fundraising social network 16. As will be appreciated, the server 11 may provide a user interface for the respective users 13a-13n to interact with the fundraising social network 16. For example, the user interface may comprise a Hypertext Markup Language (HTML) user interface rendered from a web browser, or may comprise a native operation system (OS) application interacting with the fundraising social network 16 via an application programming interface (API).

In the fundraising social network 16, a plurality of fundraising efforts 17a-17n are provided from the respective users 13a-13n. The respective users 13a-13n illustratively comprise a plurality of classes of membership. In particular, a first class of user may create and post a new fundraising effort (i.e. a dreamscape, as provided in the Follow Funding crowdfunding system, as available from Follow Funding, Inc. of Bonita Springs, Florida) and may donate to one or more of the plurality of fundraising efforts 17a-17n in the fundraising social network 16. In typical embodiments, the fundraising social network 16 may comprise a large number of active fundraising efforts 17a-17n.

A second class of user may have less privileges in the fundraising social network 16 than the first class of user and may interact with the user interface and view the plurality of fundraising efforts 17a-17n hosted on the fundraising social network 16. Although the second class of user may donate to any fundraising effort 17a-17n, the second class user cannot post a new fundraising effort to the fundraising social network 16. Of course, there may be more than two classes of users in some embodiments and with varying privileges.

The second class user can upgrade to the first class user by making a donation to any of the plurality of fundraising efforts 17a-17n hosted on the fundraising social network 16. In some embodiments, there may be a threshold donation value to upgrade to the second class user to the first class user to avoid de minimis donations to secure the user upgrade and the capability to post fundraising efforts. In other embodiments, a membership fee, either one-time or periodically recurring, may take the place of a minimum donation threshold amount in order to upgrade from a second class to a first class user account.

The server 11 is configured to receive a given donation from a given user (either first class or second class user) for a given fundraising effort within the fundraising social network 16. (Block 907). The given fundraising effort is connected to one or more other fundraising efforts. As mentioned hereinabove, only first class users can post fundraising efforts, and that requires a donation to an existing fundraising effort. The given fundraising effort has a given initial posting user (first class user), and the one or more other fundraising efforts have one or more other initial posting users (also first class users).

For example, it should be appreciated that a fundraising effort (A) is connected to fundraising efforts (B-C). The user (A) who posted the fundraising effort (A) may have donated to the fundraising efforts (B-C). The combination of fundraising efforts (A-C) are now connected (i.e. a dreamstream, as described in the Follow Funding crowdfunding system). Of course, the criteria for connecting the one or more other connected fundraising efforts can be expanded, such as, viewed fundraising efforts, fundraising efforts posted by friended users within the fundraising social network 16, etc.

The server 11 is configured to distribute the given donation between the given fundraising effort and the one or more other fundraising efforts based upon the qualifying donation values of the connected posting users.(Blocks 909, 911). In some embodiments, due to limitations in online digital payment systems, there may be a hard cap on the number of fundraising efforts receiving a donation (e.g. four) from the given donation. In these embodiments, the server 11 is configured to cull the number to meet the hard cap based upon certain criteria, such as (but not limited to) time priority of the connection.

The given qualifying donation value comprises a threshold prior donation value by the given initial posting user. The server 11 is configured to define the threshold prior donation value by the given initial posting user based upon an accumulated donation value by the given initial posting user to an initial fundraising effort.

For instance, if the given initial posting user has made a first donation of $100 to the initial fundraising effort, then the threshold prior donation value is $100. If the given initial posting user makes a second donation of $100 to the same initial fundraising effort, then the threshold prior donation value is $200, i.e. the accumulated value of both donations to this single initial fundraising effort. In this embodiment, it should be appreciated that only making more donations to this initial fundraising effort will change the threshold prior donation value, and that donations to other fundraising efforts will not change the threshold prior donation value with respect to the initial fundraising effort.

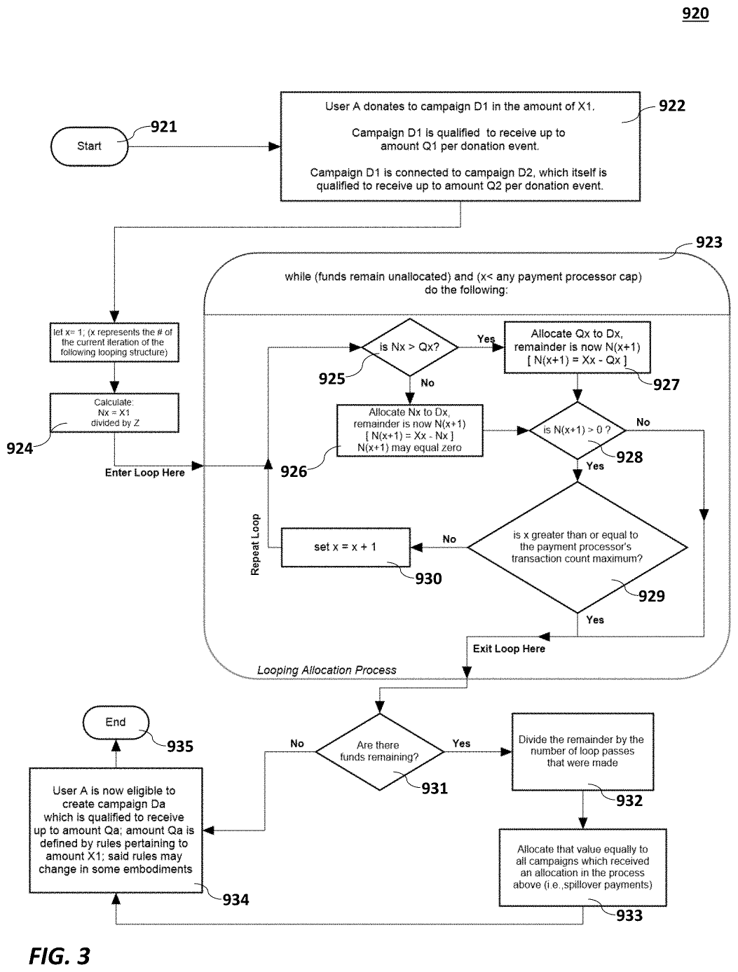

Referring now additionally to FIG. 3 and a flowchart 920, the server 11 is configured to distribute the given donation between the given fundraising effort and the one or more other fundraising efforts also based upon one or more other qualifying donation values of the one or more other initial posting users. When the given donation is greater than the given qualifying donation value, the server 11 is configured to distribute a first portion of the given qualifying donation value to the given fundraising effort equivalent to the first user's qualifying amount. (Blocks 924, 925, 926, 927). The server 11 is configured to distribute the given donation minus the first portion of the given donation value to the one or more other fundraising efforts based upon the one or more other qualifying donation values of the one or more other initial posting users. (Blocks 925-930). Subsequent to distribution of the given donation minus the first portion of the given qualifying donation value to the at least one other fundraising effort, if there exists an excess amount, the server 11 is configured to then distribute the excess amount to at least one multi-degree connected fundraising effort in accordance with the respective qualifying donation values of the multi-degree fundraising efforts currently under consideration. (Blocks 925-930).

Additionally, when the given donation is less than the given qualifying donation value, the server 11 is configured to distribute a second portion, as a set percentage (e.g. 50%), of the given donation to the given fundraising effort. (Blocks 924, 925, 926). The server 11 is configured to distribute the given donation minus the first portion of the given donation to the one or more other fundraising efforts based upon the one or more other qualifying donation values of the one or more other initial posting user(s). (Blocks 925-930). Subsequent to distribution of the given donation minus the second set percentage of the given donation to the one or more other fundraising efforts, if there exists an excess amount, the server 11 is configured to then distribute the excess amount to at least one multi-degree connected fundraising effort in accordance with the respective qualifying donation values of the multi-degree fundraising efforts currently under consideration. (Blocks 925-930).

It should be appreciated that in some embodiments, the first and second donation portions are the same value, but in other embodiments may be different values, based up the qualifying donation values of the respective fundraising efforts. Also, the first and second portions may be any value between 0-100%.

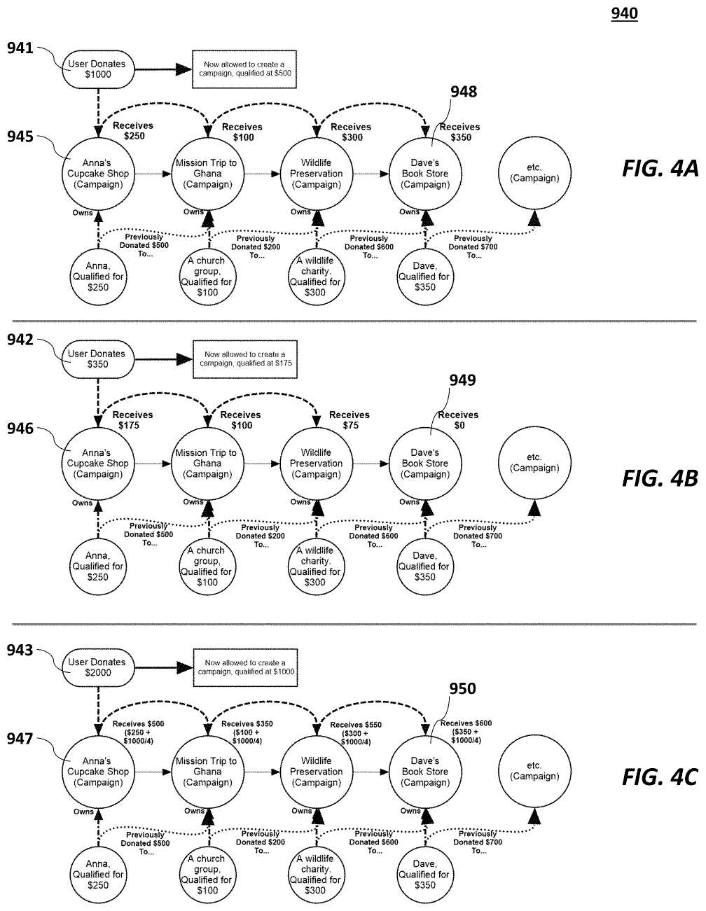

In particular, the server 11 is configured to distribute the donation based upon a donation allocation algorithm based upon a “pay it forward” methodology (i.e. the user's fundraising qualification amount is based upon how much they have contributed to other users). Referring now additionally to FIG. 4A-4C, several exemplary embodiments of the donation allocation algorithm are described in detail using the flowchart 920. (Block 921). In these exemplary embodiments, the amounts each user is qualified to receive remain constant from Figure to Figure, while the amount being donated changes in order to illustrate several possible outcomes of the distribution of the initial donation. In each of these Figures, the dotted-dash arrows show which user owns which fundraising effort, with said owner always located directly below the user's effort on the Figure, while the dotted arrows show how that user became connected to the next effort in the group. The dashed arrows show the flow of the donation allocation in the particular instance. In each such figure, the oldest fundraising effort in the group is “Dave's Book Store” (Blocks 948, 949, 950). In FIG. 4A, the amount being donated (Block 941) perfectly matches the total qualification amount of four connected fundraising efforts, and as such, each effort receives its ideal maximum amount with no remainder. In FIG. 4B, the amount being donated (Block 942) is only equal to (or less than) the total qualification of the first three fundraising efforts, leaving no allocation ($0) to pass on to the final fundraising effort. In FIG. 4C, the amount being donated (Block 943) exceeds the total qualification amounts of the four connected fundraising efforts, leaving a remainder to be equally divided among these four efforts. In each of these FIGS. 4A-4C, the donating user is now qualified to create a fundraising effort of their own, with a qualification amount in accordance with the amount they donated. In each such Figure, the newly-donating user's effort would be connected to “Anna's Cupcake Shop” (Blocks 945, 946, 947) and would be placed one position to the left of said shop.

Referencing FIG. 3, at Block 922 the first user attains first class membership by making the requisite donation (value of X0) to a first fundraising effort (D0). It should be appreciated that the first fundraising effort is connected to one or more other connected fundraising efforts. For example, the user who posted the first fundraising effort may have donated to the one or more other connected fundraising efforts.

The server 11 receives a donation (value of X1) for the newly posted second fundraising effort. (Block 922). The server 11 then calculates the ideal first set percentage (Z) of amount X1 (Block 924) and compares that value (N1) to the qualification value Q1 (Block 925), which is the amount that the fundraising effort is allowed to receive per donation. If the ideal first set percentage is greater than Q1, then Q1 is allocated to the fundraising effort (Block 927), otherwise the ideal first set percentage is so allocated. (Block 926).

This is because the donation allocation algorithm includes a rule mandating that, for any received donation, the targeted fundraising effort can receive either a maximum of up to 50% of the donated amount X1 or amount Q1 (the targeted effort's qualification amount), whichever is lower. When the received donation is smaller than Q1, the targeted fundraising effort can receive up to 50% of the donated amount. In other embodiments, allocation percentages may be altered by changes in rules.

Of course, as mentioned hereinabove, the maximum value received per donation event can be increased by making additional donations to the originating fundraising effort. In other embodiments, the maximum value is set by donations to any fundraising effort. In these embodiments, assuming the posting user has donated to multiple fundraising efforts, the largest donation would set the maximum value, and this can be increased by simply donating a greater value than prior. Hence, the user is encouraged to be generous in the donations to others, as it literally caps the amount the user can receive for his or her own fundraising effort.

Also, the 50% cap rule applies to the one or more other connected fundraising efforts and their corresponding one or more other posting users. If the divided portion is greater than a cap for the respective connected fundraising efforts, there are several options for the excess funds.

In the illustrated embodiment, the excess is distributed to at least one multi-degree connected fundraising effort by looping through a subset of the flowchart (Block group 923). In other words, the excess would be distributed to second degree connections, third degree connections and so forth (i.e. the funds move through the loop), again based upon the respective qualifying donation values until there are no excess funds. Thereby, a single donation can spread among a large number of the plurality of fundraising efforts 17a-17n.

In other embodiments (Blocks 931-933), the excess is divided equally among the fundraising efforts within the payment processor's transaction count maximum, which would give them a windfall above and beyond their respective caps (e.g. when there is a payment system party number cap). (Blocks 929, 931-933). In other embodiments, the excess is divided among the same one or more other connected fundraising efforts based upon some criteria (e.g. respective qualifying donation values), which would give them a windfall above and beyond their respective caps.

In yet another embodiment, the excess would be received by the fundraising social network 16 as a system resource, i.e. to pay for the implementation and overhead of the crowd fundraising social network system 10. Of course, the preference is that each of the respective users 13a-13n would pay a periodic fee to be a member of the fundraising social network 16.

If 50% of the remaining funds of the new donation X1 has a value less than the qualification value of the target fundraising effort, then up to 50% of X1 is assigned to the second fundraising effort, and any remaining portion thereafter is divided to the one or more other connected fundraising efforts, each according to their individual qualification amounts. (Block group 923, Blocks 931-933). The same process is repeated for all new donations. (Blocks 921-934).

With reference again to FIGS. 1 and 2, another aspect is directed to a method for operating a crowd fundraising social network system 10. The method includes operating a plurality of devices 12a-12n in communication with a server 11 and having respective users 13a-13n. (Blocks 901, 903). The method includes providing a fundraising social network 16. The respective users 13a-13n are members in the fundraising social network 16. The method comprises receiving a given donation for a given fundraising effort within the fundraising social network. The given fundraising effort is connected to at least one other fundraising effort, and the given fundraising effort has a given initial posting user. The at least one other fundraising effort has at least one other initial posting user. The method comprises distributing the given donation between the given fundraising effort and the at least one other fundraising effort based upon a given qualifying donation value for the given initial posting user. The given qualifying donation value comprises a threshold prior donation value by the given initial posting user. (Blocks 905, 907, 909, 911).

Advantageously, the crowd fundraising social network system 10 may provide for robust and ethical online fundraising. In particular, in contrast to typical crowd fundraising approaches, the amount received by a user is tied permanently to the amount the user has donated to other users, which encourages generosity. Moreover, for any donation received, at least 50% of the donation is spread amongst connected fundraising efforts. Indeed, in the fundraising social network 16, the privilege to post a fundraising effort is tied to the user making a donation to another fundraising effort.

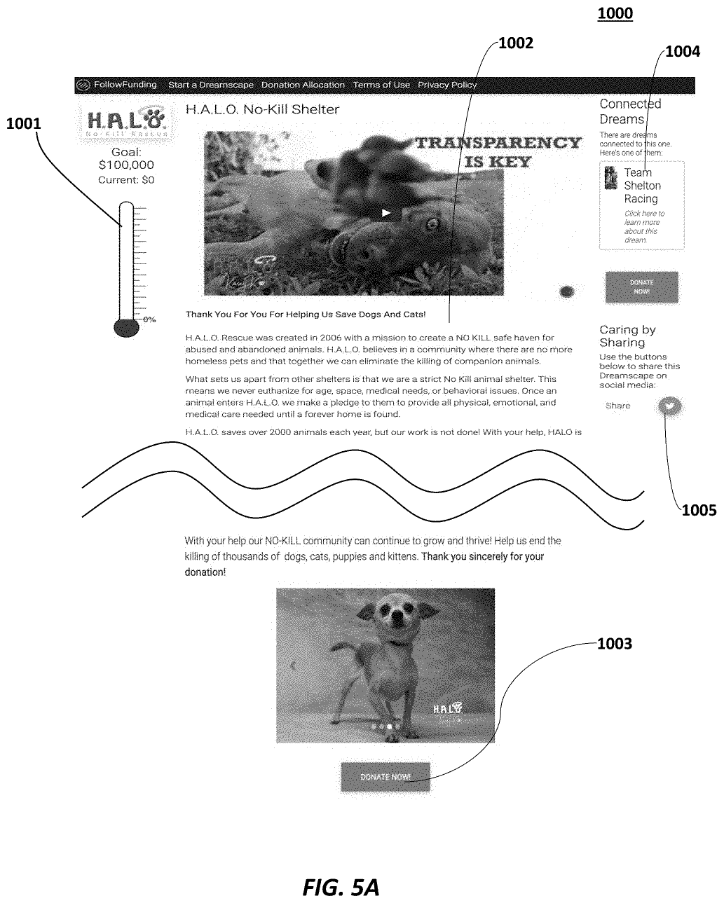

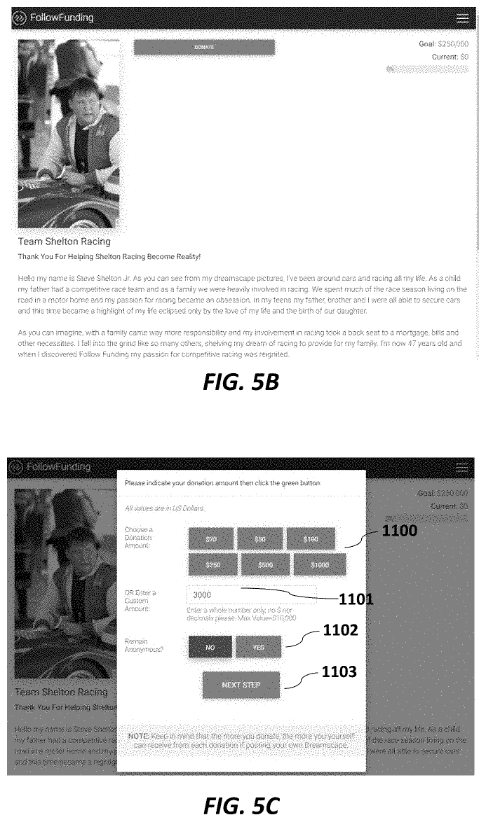

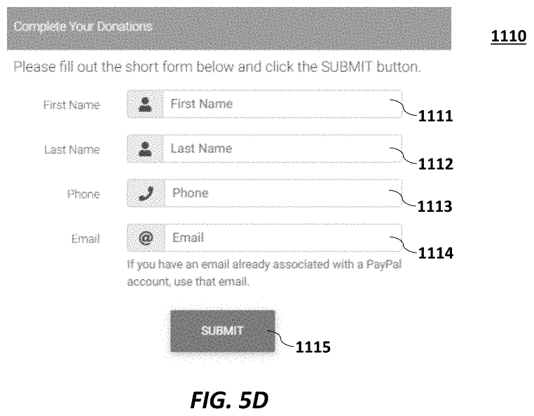

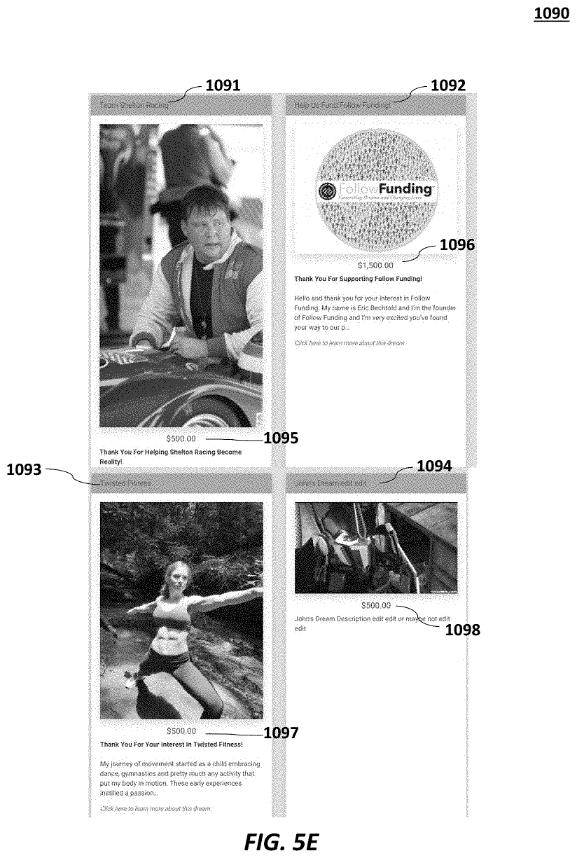

Referring now additionally to FIGS. 5A-5G, a user interface of an embodiment of the crowd fundraising social network system 10 is now described. In FIG. 5A, the landing page 1000 for a fundraising effort is shown as viewed from a large screen device, such as a desktop computer operating in 1080p display mode. The landing page 1000 illustratively includes a current status icon 1001 (e.g. illustrated thermometer icon) showing a fundraising goal of the associated fundraising effort. The landing page 1000 also illustratively comprises a narrative description 1002 (e.g. text based or video based) of the associated fundraising effort goal, and a “donate now” button 1003. Additionally, the landing page 1000 illustratively includes a connected fundraising efforts tool 1004 (connected efforts) showing a user which fundraising efforts are connected to the associated fundraising effort, and a social media network icon 1005 for sharing within respective social media networks (e.g. illustrated Twitter, FaceBook, Instagram, etc.). In some embodiments, the landing page 1000 illustratively includes a donation history for the current fundraising effort (e.g. donor ID and donation amount).

In FIG. 5B, the same landing page 1000 for a fundraising effort is shown, but as viewed from a small screen device, such as a laptop computer, tablet or phone, or a desktop computer with a smaller screen. The landing page uses adaptive screen size detection technology to reconfigure itself into an arrangement more convenient and appropriate to the size of the user's device. All of the same controls, blocks and content are present as in FIG. 5A, but are arranged and sized differently.

In FIG. 5C, the interface for chosing a donation amount is displayed. This interface is displayed as a result of clicking the donation button in either FIGS. 5A or 5B (depending on the user's screen size). The user is given a choice between a set of preconfigured donation amounts 1100, or may enter a custom amount of their own choosing 1101. The user is further presented with the choice to remain anonymous 1102. Finally, the user is presented with a button to proceed to the next step 1103.

In FIG. 5D, the user is asked to submit information necessary to the processing of the transaction, such as basic contact information in fields 1111-1114. The user submits this information with button 1115 and proceeds to FIG. 5E.

In FIG. 5E, the user is shown the connected fundraising efforts that their selected donation amount will fund (1091-1094), and in what amounts (1095-1098). This part of the interface is the result of the user clicking the submit button in FIG. 5D. The user is then presented with a button to finalize the transaction.

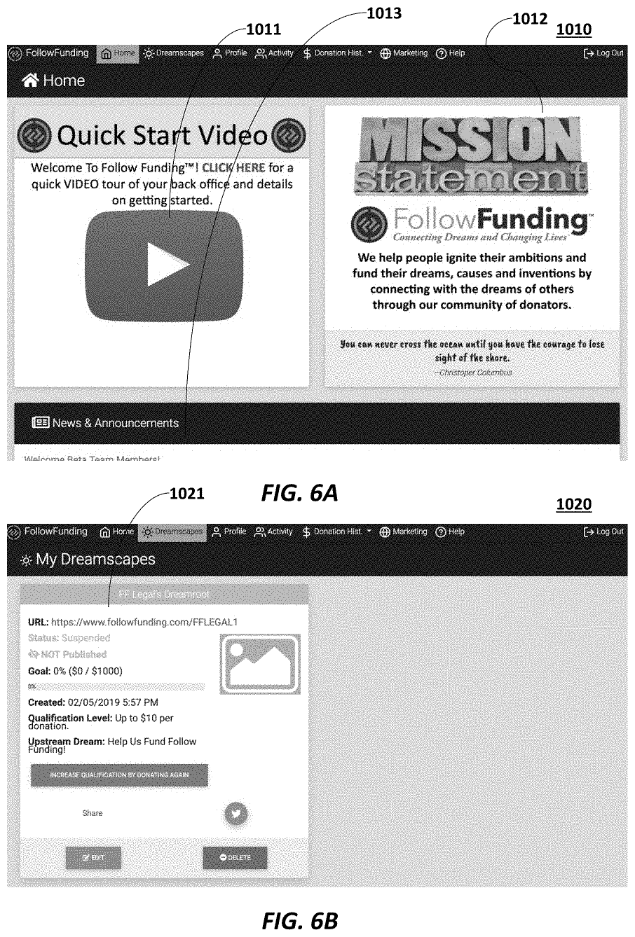

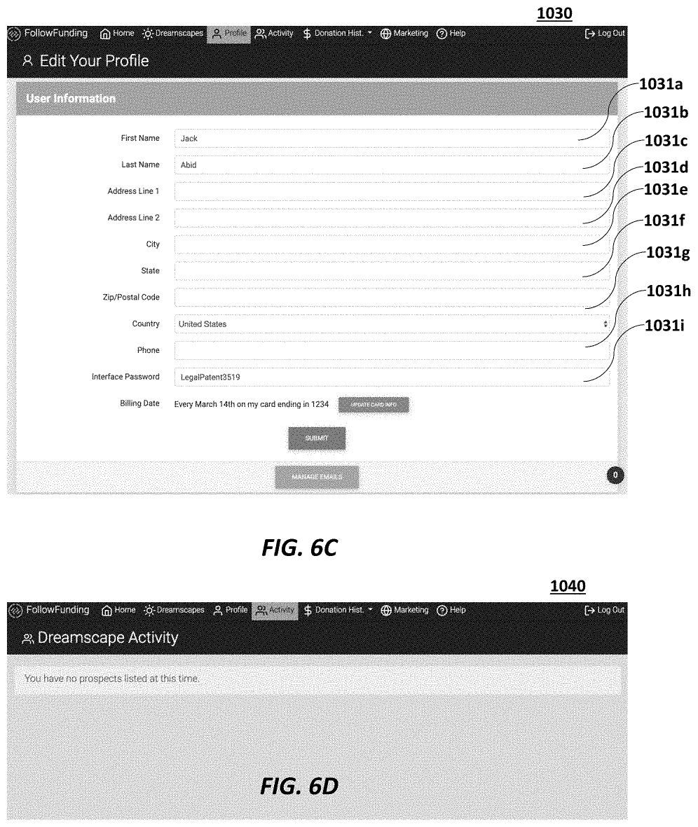

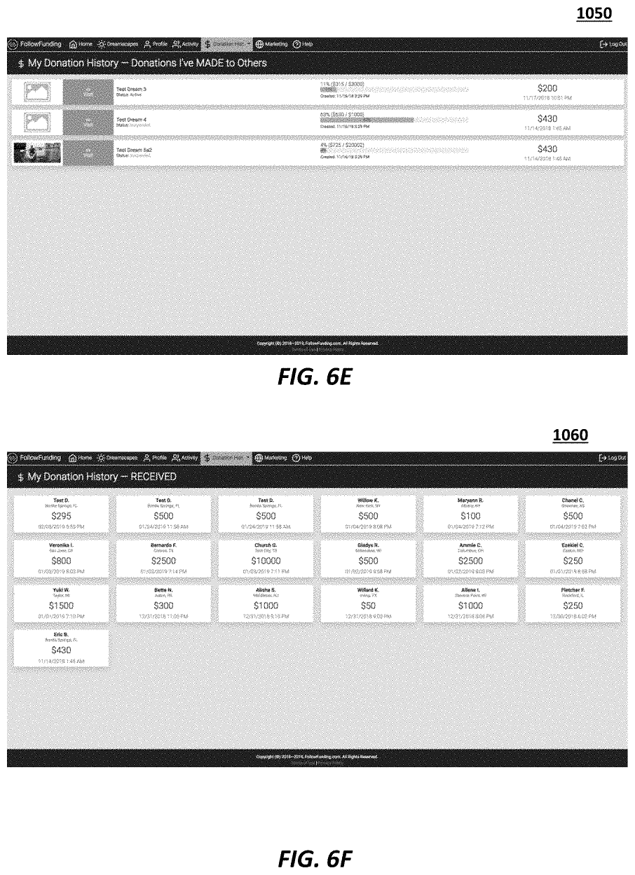

In FIG. 6A, the dashboard for a logged-in user is shown, and includes a quick start video 1011 and a mission statement 1012. The landing page 1010 of the dashboard illustratively includes an announcements interface 1013 for listing system messages for the crowd fundraising social network system 10.

In FIG. 6B, the fundraising effort page 1020 of the dashboard is shown. The fundraising effort page 1020 of the dashboard illustratively comprises a status interface 1021 for the user's fundraising effort. Here, the logged-in user may change settings for the fundraising effort

In FIG. 6C, the profile page 1030 of the dashboard is shown. The profile page 1030 of the dashboard illustratively comprises a plurality of editable fields 1031a-1031i for the logged-in user to adjust respective values. In FIG. 6D, the activity page 1040 of the dashboard is shown. The activity page 1040 of the dashboard illustratively comprises activity data (e.g. prospective donors who have visited this user's fundraising effort(s)) for the logged-in user; such prospective users may or may not have actually donated, or merely visited the fundraising effort's page. In FIGS. 6E and 6F, the respective donations made and received pages 1050, 1060 of the dashboard is shown, which show existing donation data.

In the following, another exemplary discussion of the donation allocation algorithm is now provided. When making a donation on the crowd fundraising social network system 10, the donor is not making a donation to fund only one person's dream, project, invention or cause (i.e. aforementioned fundraising effort), as done in other typical crowd funding platforms. In fact, the donor is helping up to four (or more depending on the embodiment) connected fundraising efforts achieve their financing goals at the same time.

### Allocation Rules:

In this embodiment, a donation-receiving user can only get paid up to 50% of the amount the donation receiving user has donated, and the donation receiving user can only receive up to 50% of the amount being donated. To illustrate this principle, suppose a user made a personal donation of $500 before posting their own fundraising effort. The action of donating said $500 would qualify the user to receive up to $250 total per individual donation by other users.

If a user posts a fundraising effort and a donor makes a $100 donation, the posting user would receive $50, which is 50% of the total donation, and the other $50 would be allocated the other fundraising efforts connected with the receiving fundraising effort. The user receives $50 because it was 50% of the total amount being donated in this instance. Had the donator in this example donated $500 or above, the user would have received a $250 donation, which is the maximum qualifying value in this illustration.

Using the same $100 donation example, the method of allocating additional donations is described. Here, positing that the primary posting user is connected with another posting user who donated $50, in such an instance, when the $50 remainder is attempted to be allocated, they would only receive $25, which is 50% of the total amount they themselves have donated, which is their maximum donation qualification value. This leaves the remaining $25 to continue being allocated to subsequently-connected fundraising efforts.

Any monies remaining after all connected fundraising efforts are funded according the combination of their respective qualification values and any limitations imposed by the relevant payment processing systems shall be distributed among the aforementioned fundraising efforts in equal portion according to the number of connected fundraising efforts under discussion. For example, if there are N number of fundraising efforts under consideration, the remaining monies shall be split evenly by dividing by N and allocating that value among them equally (These allocations are known as spill-over donations in Follow Funding).

It's important to note that unlike other crowdfunding platforms, the crowd fundraising social network system 10 does not take a percentage of each donation, but makes sure the entire amount minus third-party processing fees is allocated to those using the platform following the rules as outlined in the aforementioned illustrations.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A crowd fundraising social network system comprising:
a server; and
a plurality of devices in communication with said server and having respective users;
said server configured to
provide a fundraising social network, the respective users being members in the fundraising social network,
receive a given donation for a given fundraising effort within the fundraising social network, the given fundraising effort being connected to at least one other fundraising effort,
the given fundraising effort having a given initial posting user, and the at least one other fundraising effort having at least one other initial posting user, and
distribute the given donation between the given fundraising effort and the at least one other fundraising effort based upon a given qualifying donation value for the given initial posting user, the given qualifying donation value comprising a threshold prior donation value by the given initial posting user.

2. The crowd fundraising social network system of claim 1 wherein said server is configured to distribute the given donation between the given fundraising effort and the at least one other fundraising effort based upon at least one other qualifying donation value of the at least one other initial posting user.

3. The crowd fundraising social network system of claim 2 wherein when the given donation is greater than the given qualifying donation value, said server is configured to distribute a first set percentage of the given qualifying donation value to the given fundraising effort.

4. The crowd fundraising social network system of claim 3 wherein said server is configured to distribute the given donation minus the first set percentage of the given qualifying donation value to the at least one other fundraising effort based upon the at least one other qualifying donation value of the at least one other initial posting user.

5. The crowd fundraising social network system of claim 4 wherein subsequent to distribution of the given donation minus the first set percentage of the given qualifying donation value to the at least one other fundraising effort, if there exists an excess amount, then distribute the excess amount to at least one multi-degree connected fundraising effort.

6. The crowd fundraising social network system of claim 5 wherein when the given donation is less than the given qualifying donation value, said server is configured to distribute a second set percentage of the given donation to the given fundraising effort.

7. The crowd fundraising social network system of claim 6 wherein said server is configured to distribute the given donation minus the second set percentage of the given donation to the at least one other fundraising effort based upon the at least one other qualifying donation value of the at least one other initial posting user.

8. The crowd fundraising social network system of claim 7 wherein subsequent to distribution of the given donation minus the second set percentage of the given donation to the at least one other fundraising effort, if there exists an excess amount, then distribute the excess amount to at least one multi-degree connected fundraising effort.

9. The crowd fundraising social network system of claim 1 wherein said server is configured to define the threshold prior donation value by the given initial posting user based upon an accumulated donation value by the given initial posting user to an initial fundraising effort.

10. A crowd fundraising social network system comprising:
a server; and
a plurality of devices in communication with said server and having respective users;
said server configured to
provide a fundraising social network, the respective users being members in the fundraising social network,
receive a given donation for a given fundraising effort within the fundraising social network, the given fundraising effort being connected to at least one other fundraising effort,
the given fundraising effort having a given initial posting user, and the at least one other fundraising effort having at least one other initial posting user,
define a threshold prior donation value by the given initial posting user based upon an accumulated donation value by the given initial posting user to an initial fundraising effort, and
distribute the given donation between the given fundraising effort and the at least one other fundraising effort based upon a given qualifying donation value for the given initial posting user and at least one other qualifying donation value of the at least one other initial posting user, the given qualifying donation value comprising the threshold prior donation value by the given initial posting user.

11. The crowd fundraising social network system of claim 10 wherein when the given donation is greater than the given qualifying donation value, said server is configured to distribute a first set percentage of the given qualifying donation value to the given fundraising effort.

12. The crowd fundraising social network system of claim 11 wherein said server is configured to distribute the given donation minus the first set percentage of the given qualifying donation value to the at least one other fundraising effort based upon the at least one other qualifying donation value of the at least one other initial posting user.

13. The crowd fundraising social network system of claim 12 wherein subsequent to distribution of the given donation minus the first set percentage of the given qualifying donation value to the at least one other fundraising effort, if there exists an excess amount, then distribute the excess amount to at least one multi-degree connected fundraising effort.

14. The crowd fundraising social network system of claim 13 wherein when the given donation is less than the given qualifying donation value, said server is configured to distribute second set percentage of the given donation to the given fundraising effort.

15. The crowd fundraising social network system of claim 14 wherein said server is configured to distribute the given donation minus the second set percentage of the given donation to the at least one other fundraising effort based upon the at least one other qualifying donation value of the at least one other initial posting user.

16. The crowd fundraising social network system of claim 15 wherein subsequent to distribution of the given donation minus the second set percentage of the given donation to the at least one other fundraising effort, if there exists an excess amount, then distribute the excess amount to at least one multi-degree connected fundraising effort.

17. A method for operating a crowd fundraising social network system, the method comprising:
operating a plurality of devices in communication with a server, the plurality of devices having respective users;
providing a fundraising social network, the respective users being members in the fundraising social network;
receiving a given donation for a given fundraising effort within the fundraising social network, the given fundraising effort being connected to at least one other fundraising effort;
the given fundraising effort having a given initial posting user, and the at least one other fundraising effort having at least one other initial posting user; and
distributing the given donation between the given fundraising effort and the at least one other fundraising effort based upon a given qualifying donation value for the given initial posting user, the given qualifying donation value comprising a threshold prior donation value by the given initial posting user.

18. The method of claim 17 further comprising distributing the given donation between the given fundraising effort and the at least one other fundraising effort based upon at least one other qualifying donation value of the at least one other initial posting user.

19. The method of claim 18 further comprising, when the given donation is greater than the given qualifying donation value, distributing a first set percentage of the given qualifying donation value to the given fundraising effort.

20. The method of claim 19 further comprising when the given donation is less than the given qualifying donation value, distributing a second set percentage of the given donation to the given fundraising effort.
